(19) United States
(12) Patent Application Publication
(10) Pub. No.: US 2010/0241515 A1
(43) Pub. Date: Sep. 23, 2010

(54) System and Method for Attention-Grabbing Display Results for Sponsored Online Advertising Campaigns

(76) Inventor: Anand Katti, Karnuiaka (IN)

Correspondence Address: STATTLER - SUH PC, 60 SOUTH MARKET STREET, SUITE 480, SAN JOSE, CA, 95113, US

(21) Appl. No.: 12/409,222

(22) Filed: Mar. 23, 2009

(51) Int. Cl. G06Q 30/00; G06F 3/048; G06F 17/21

(52) U.S. Cl. 705/14.72; 715/764; 715/269

(57) ABSTRACT

A method for creating a stylized online advertisement for sponsored search web pages using a stylized catch phrase. An advertiser is presented an interface for composing the advertisement wherein the interface for composing includes capturing the text of a catch phrase together with a description of a style or styles to be applied to the catch phrase. Applying the styles results in creating a stylized catch phrase which is then subjected to tests and/or editorial reviews, resulting in approving the stylized catch phrase for use in the context of the online advertisement. The stylized advertisement is composited together with search results, and the composite is then transmitted, thus delivering the stylized online advertisement impression. The tests and editorial reviews include tests and previews for managing how the stylized advertisement will look when rendered on different screens (e.g. a large computer monitor, a small monitor a smart phone or other device).

### FIELD OF THE INVENTION

The present invention is directed toward the creation of advertising and marketing campaigns using advertiser display preferences.

### BACKGROUND OF THE INVENTION

Online advertising and marketing campaigns often include presenting advertisements to a user in response to a user's search query entered into a web search engine (e.g. Yahoo, Baidu, AltaVista, Google, etc). Generally, the results of the requested search are compiled into one or more web pages, and websites or other resources are displayed in a textual listing of URLs together with a textual caption. In the case that the web page with the returned results can contain advertising, the advertising text is composited with the search results web page, thus commingling text ads with search results. Especially in situations where a search results web page contains a plurality of sponsored advertisements, one advertisement does not necessarily stand apart distinctly from another advertisement. Thus, a method for displaying a distinctive advertisement and a method for creation of an advertising campaign that facilitates specification of distinctive characteristics of the sponsored advertisement is needed.

Other automated features and advantages of the present invention will be apparent from the accompanying drawings, and from the detailed description that follows below.

### SUMMARY OF THE INVENTION

A method for creating a stylized online advertisement for sponsored search web pages using a stylized catch phrase. An advertiser is presented with an interface for composing the advertisement wherein the interface for composing includes capturing the text of a catch phrase together with options to define the style or styles to be applied to the catch phrase. Applying the styles results in creating a stylized catch phrase that is then presented for tests and/or editorial reviews, resulting in the option to approve the stylized catch phrase for use in the context of the online advertisement. The stylized advertisement is composited together with search results, and the composite is then transmitted, thus delivering the stylized online advertisement impression. The tests and editorial reviews include tests and previews for managing how the stylized advertisement will look when rendered on different screens (e.g. a large computer monitor, a small monitor, a smart phone or other device, etc).

### BRIEF DESCRIPTION OF THE DRAWINGS

The novel features of the invention are set forth in the appended claims. However, for purpose of explanation, several embodiments of the invention are set forth in the following figures.

FIG. 1A shows an ad network environment in which some embodiments operate.

FIG. 1B shows an ad network environment including an auction engine server in which some embodiments operate.

FIG. 2A depicts a search results web page, according to an exemplary embodiment.

FIG. 2B depicts a search results web page including a bounding box, according to an exemplary embodiment.

FIG. 3A shows a screen device with a multi-step procedure for creating a campaign, according to one embodiment.

FIG. 3B shows a screen device for defining advertising copy for an advertising campaign, according to an exemplary embodiment.

FIG. 4 is a diagrammatic representation of several computer systems in the exemplary form of a client server network, within which environment a communication protocol may be executed, according to one embodiment.

FIG. 5 is an operations chart showing a system and method for attention-grabbing display results for sponsored online advertising campaigns, according to one embodiment.

FIG. 6 is an operations chart showing a system and method for applying style to a catch phrase, according to one embodiment.

FIG. 7 is an operations chart of a system and method for approving a stylized catch phrase, according to one embodiment.

FIG. 8 is a diagrammatic representation of a machine in the exemplary form of a computer system, within which a set of instructions may be executed, according to one embodiment.

FIG. 9A is a diagrammatic representation of several computer systems in the exemplary form of a client server network, within which environment a communication protocol may be executed, according to one embodiment.

FIG. 9B is a diagrammatic representation of client server network environment, within which environment a communication protocol may be executed, according to one embodiment.

### DETAILED DESCRIPTION

In the following description, numerous details are set forth for purposes of explanation. However, one of ordinary skill in the art will realize that the invention may be practiced without the use of these specific details. In other instances, well-known structures and devices are shown in block diagram form in order to not obscure the description of the invention with unnecessary detail.

In some situations, an advertiser is sufficiently sophisticated with respect to creating and optimizing advertising-related content (i.e. creatives) to be used in the advertiser's advertising campaigns. However, in certain situations when small advertisers are concerned, development of creatives, especially creatives within the context of sponsored search advertising, present a barrier to launching an effective advertising campaign. Even when a small advertiser is capable of developing the advertising copy, there still remains a barrier for the small advertiser to specify a distinctive advertisement.

In order to surmount the aforementioned limitations in the state of the art, and to lower the real and perceived barriers attendant to creating a sponsored search advertising campaign, herein are disclosed techniques to reduce the complexity of creating such an advertising campaign, while still permitting the small advertiser to specify distinctive advertisement copy.

Application of these techniques results in (a) a lowered barrier to entry for small advertisers, (b) automatically generated advertising artwork, and (c) more distinctive advertisements. Of course, a lower barrier to entry is likely to bring more advertisers into an advertising network, and with more advertisers, a higher revenue potential.

### Section I: General Terms and Network Environment

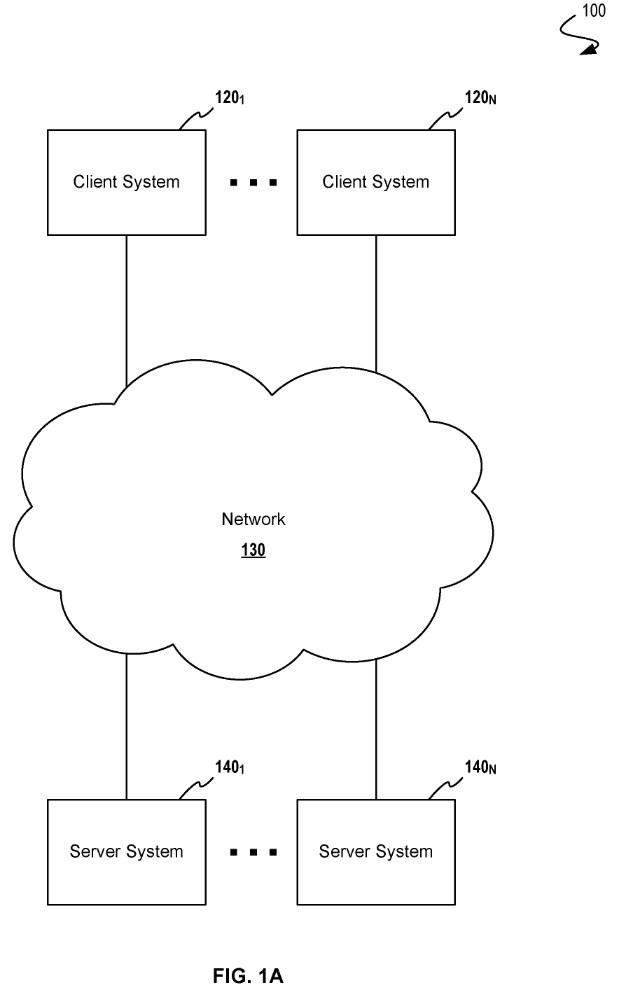

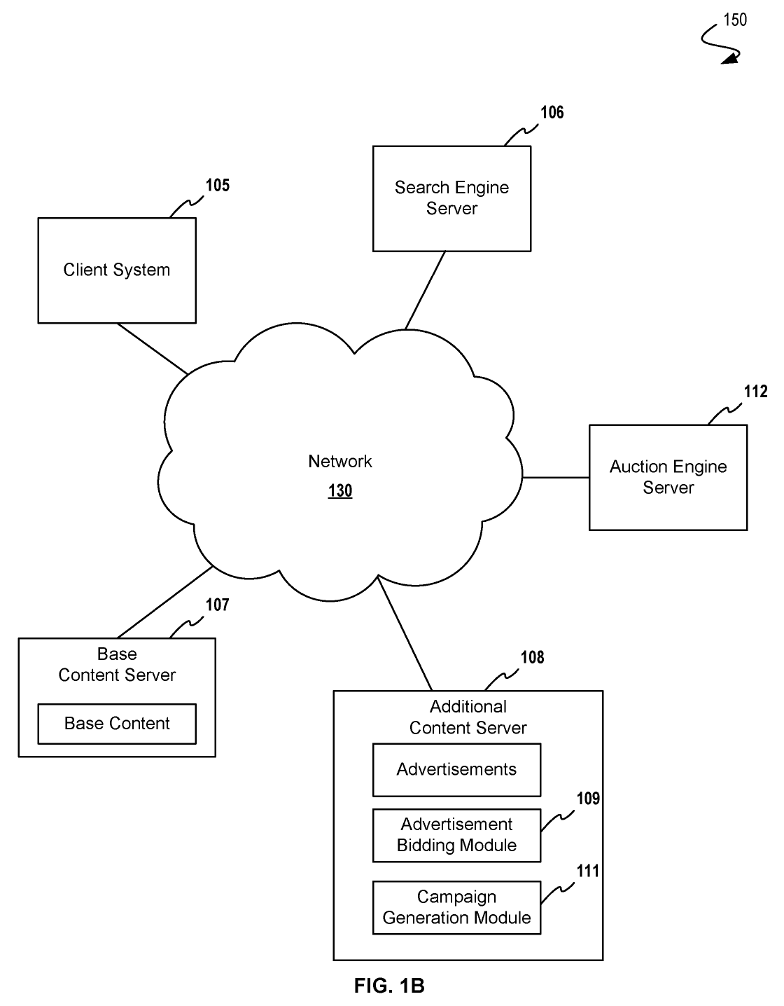

FIG. 1A shows an ad network environment in which some embodiments operate. As shown, the network environment 100 includes client systems 120₁ to 120_{N} and server systems 140₁ to 140_{N}, each coupled to a network 130 (such as the Internet or an intranet, an extranet, a virtual private network, a non-TCP/IP based network, any LAN or WAN, or the like). In some embodiments, the client systems 120₁ to 120_{N} and/or system servers 140₁ to 140_{N} are configured to perform the methods described herein. The methods of some embodiments may be implemented in software or in hardware, or using both software and hardware. In some embodiments, a system 100 is configured to present creative-related options and other campaign-related variables to be displayed to a user. As used herein, the term server applies to any of the aforementioned servers, 140₁ to 140_{N}, or the term server might more generally refer to any computing platform, possibly including any one or more client systems 120₁ to 120_{N}.

A server system 140₁ may include a single server computer or a plurality of server computers 140₁ to 140_{N} for providing a variety of network services (e.g. presenting advertisements, presenting an advertising campaign dashboard, performing search queries, providing base content, capturing and filtering web page information and/or user activity data, etc). In various embodiments, each client system 120 is configured to communicate with a server system 140. The client system 120 may be implemented in the form of a desktop personal computer, a workstation, a laptop computer, a PDA, a cell phone, any wireless application protocol (WAP) enabled device, or any other device capable of communicating directly or indirectly with a network. The client system 120 typically runs a web browsing program (such as Microsoft's Internet Explorer™ browser, Netscape's Navigator™ browser, the Mozilla™ browser, the Opera™ browser, a WAP-enabled browser in the case of a cell phone, a PDA or other wireless device, or the like) allowing a user of the client system 120 to interact through the network 130 and receive content from server systems 140₁ to 140_{N}. The client system 120 typically includes one or more user interface devices (such as a keyboard, a mouse, a roller ball, a touch screen, a pen or the like) for interacting with a graphical user interface (GUI) of the web browser on a display (e.g. monitor screen, LCD display, etc).

FIG. 1B shows an ad network environment 150 including an additional content server 108 in which some embodiments operate. The advertising system 150 may include zero or more client systems 105, zero or more base content servers (publishers) 107, zero or more additional content servers 108, and/or zero or more search engine servers 106, each connected to a network 130 (e.g. Internet, intranet, subnet, etc). The advertising system 150 might be further configured to select additional content (e.g. advertisements) to be sent to a user/client system, possibly together with related base content (e.g. base content for an auto dealership might include additional content in the form of an advertisement for a featured automobile).

More specifically, the client system 105 is configured to request and receive content (e.g. in the form of web pages) from a base content server 107 and/or additional content servers 108, where such content may include base content (a requested web page) and/or additional content (advertisements, an advertising campaign control panel, a dashboard, a keyword input screen device, etc).

In other embodiments, the search engine server 106 is configured to receive a search query from the client system 105, perform the search query (comprising one or more terms), attach the search query terms to a search results web page (for example, within the uniform resource locator address), and serve the search results web page to the client system 105, the search results web page typically comprising search results in the form of one or more hyperlinks to one or more landing web pages, plus an area for sponsored search advertisements.

In still other embodiments, a plurality of characteristics (e.g. text, styles, images, links, etc) of an advertisement is structured so as to be dynamically configured based upon one or more bid phrases and/or one or more keywords/terms. The additional content server 108 may include an advertisement bidding module 109 which, in conjunction with an auction engine server 112 is used to determine which advertisements (if any) from the additional content server 108 to compose into a search results web page and serve to the client including one or more areas for sponsored advertisements.

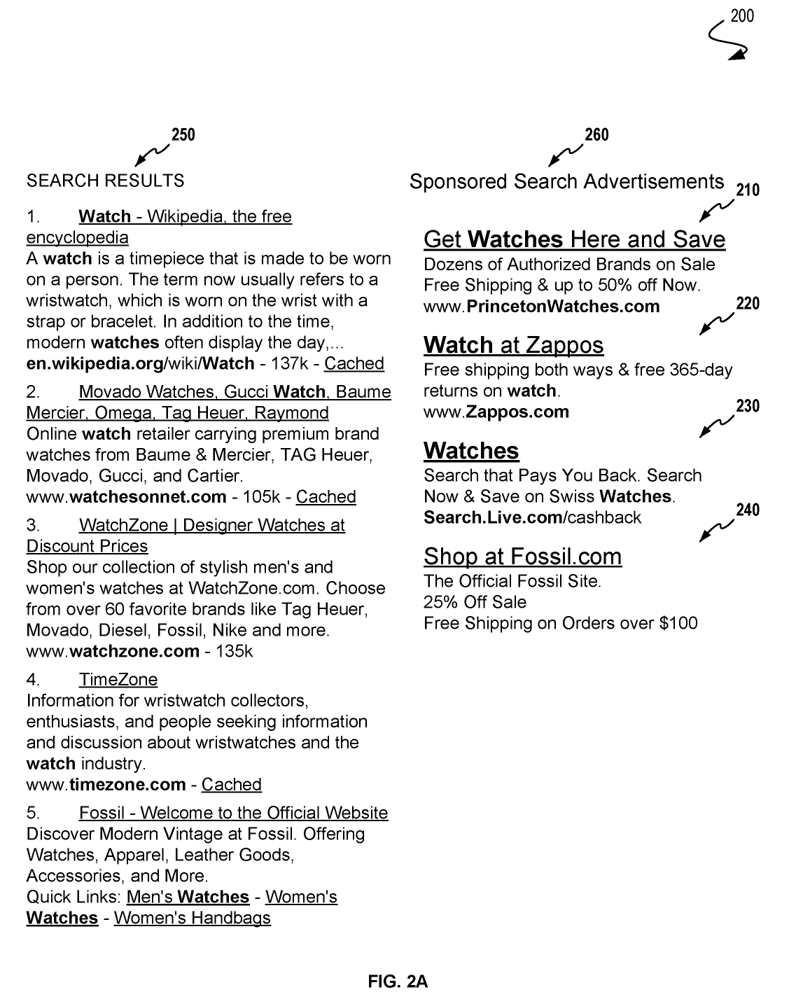

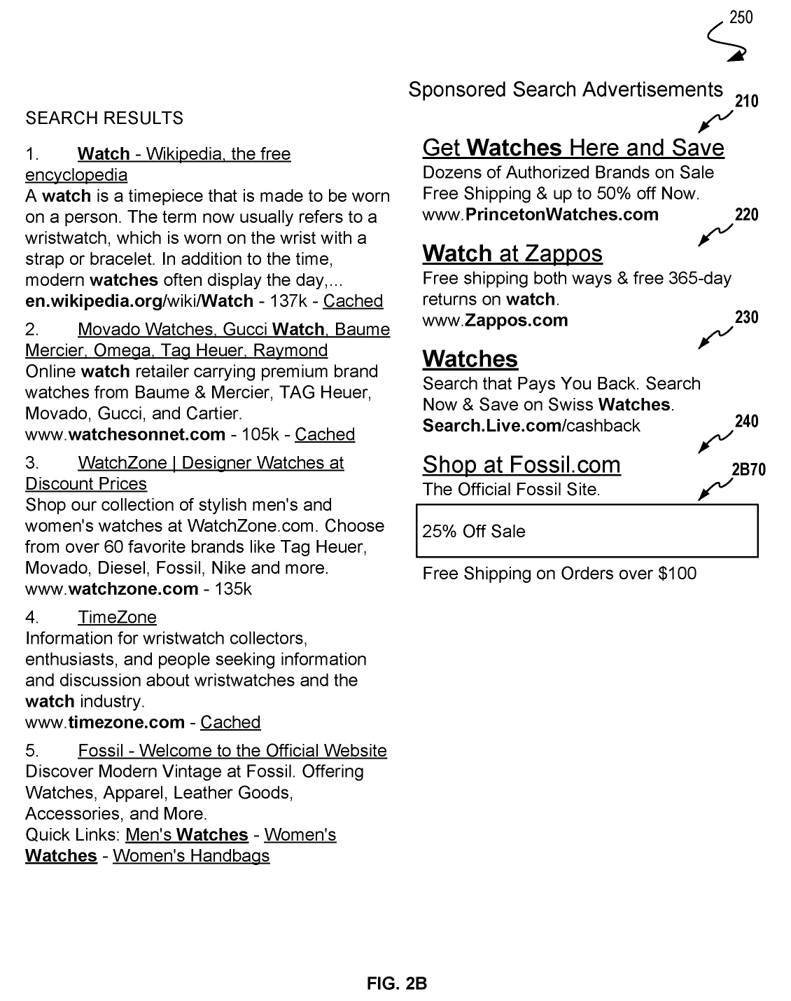

FIG. 2A depicts such a search results web page, in this case returning results returned for the keyword “watch”. As shown, a web page 200 includes an area for search results 250 and an area for sponsored search advertisements 260. The area for sponsored search advertisements 260 includes several sponsored advertisements 210, 220, 230, and 240. Of note, the sponsored search advertisements 260 are presented in text only.

FIG. 2B depicts a web page, including text line at 2B70. As shown, the text line 2B70 includes a bounding box. In some embodiments of the invention, the text displays at the client system as a catch phrase, sometimes treated as flashy text. Examples of flashy text include text in an offset typeface, text in a different point size, text presented in a complementary color, text with shadow, text treated or displayed with a blinking feature, text treated with or displayed in an animated display object, etc. As shown, the flashy text is bounded by bounding box at 2B70, however this is purely an exemplary embodiment, and any number of lines or regions could be bounded by an imaginary bounding box, and the text contents treated as a catch phrase.

Returning to the discussion of the system 150, the additional content server 108 may include an advertisement biding module 109 which, in conjunction with an auction engine server 112 is used to determine which advertisements (if any) from the additional content server 108 to serve. In some cases the auction might return a plurality of winning advertisements where the advertisement won by the highest bid is composited into the search results web page in the most prominent (e.g. top, first, highest, etc) position within the areas for sponsored search advertisements, and the second highest bidder's advertisement is composited into the second most prominent location, etc. Embodiments of flashy text offer the advertiser the option to increase visibility of an advertisement in a manner other than bidding higher bids in order to secure the first most prominent spot or second most prominent spot, etc. Of course when greater visibility can be correlated to higher click rate, greater visibility can be correlated to higher revenues (e.g. increased demand for high-click-rate advertisements, increased bids for specific keywords, increased reserve for keywords, etc).

Of course, to facilitate the selection and auction process, it might be convenient for a sponsor (e.g. an advertiser) to establish a database of advertisements, possibly including catch phrases, bid phrases and other parameters used in the management of the how, when, where, and under what circumstances an advertisement is shown. Such a collection of parameters is termed an advertising campaign. In one embodiment, an additional content server might contain a campaign generation module 111, which is configured to manually, or semi-automatically, or fully-automatically populate an advertising campaign with one or more creative advertisements (i.e. creatives) employing flashy text.

### Section II: Creation and Presentation of an Advertising Campaign Using Flashy Text

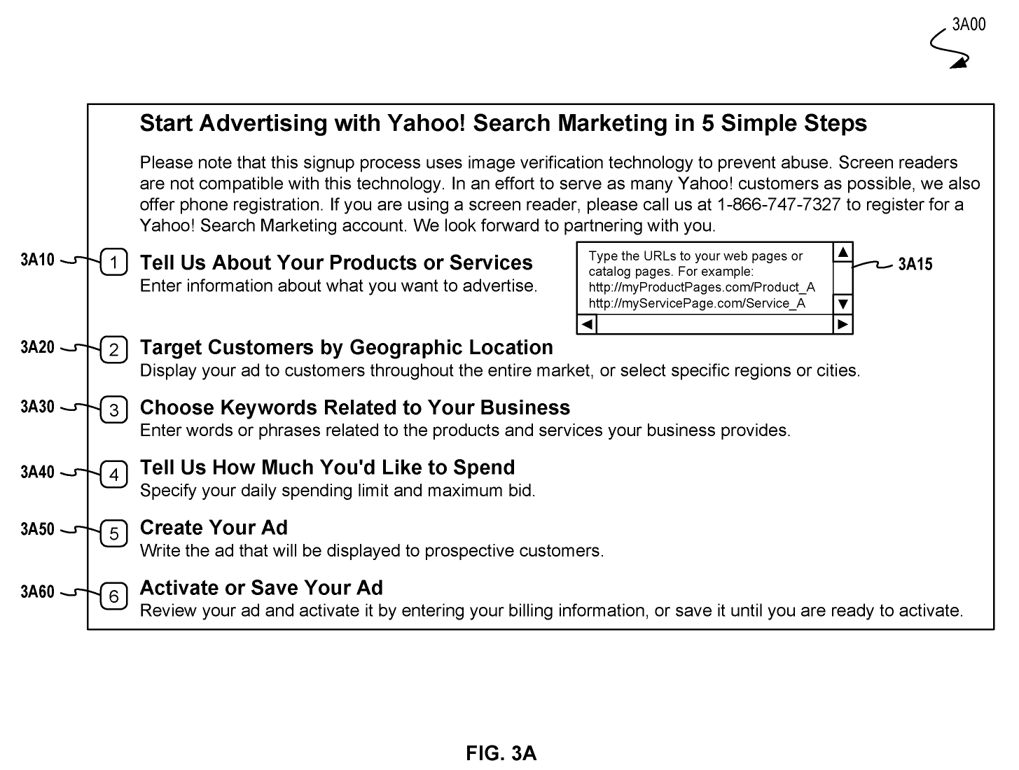

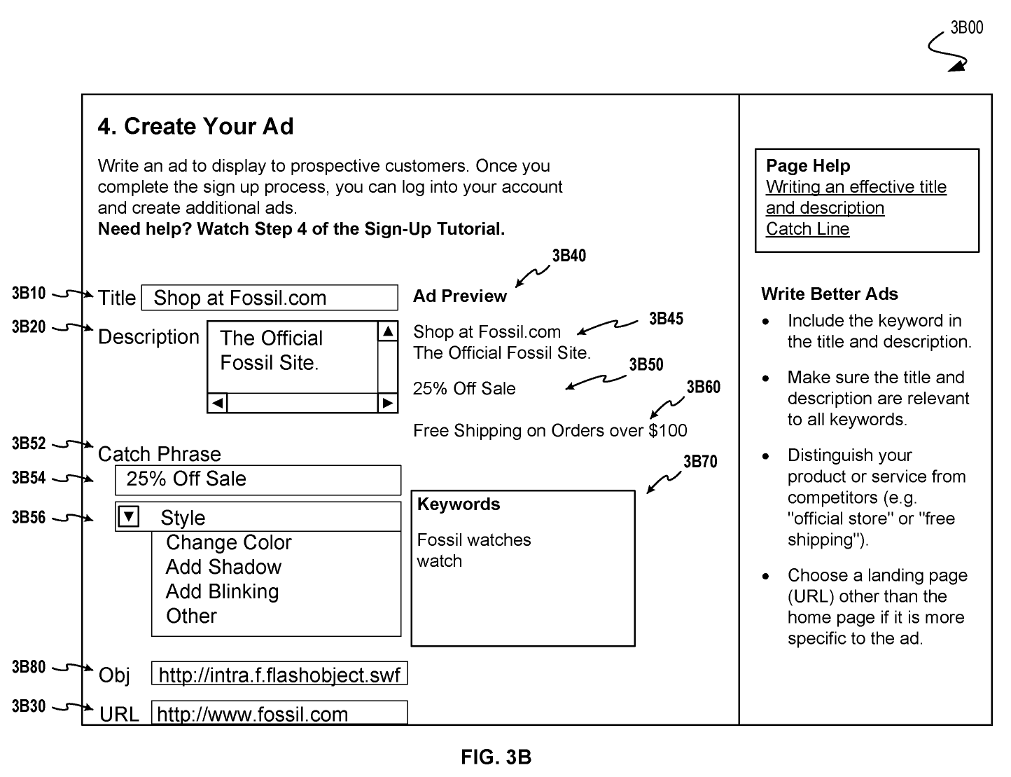

FIG. 3A shows a screen device 3A00 with a multi-step procedure for creating a campaign, according to one embodiment. As shown, the steps for creating a campaign might include providing some initial information about the products or services to be advertised 3A10, establishing geographic coverage 3A20, defining keywords and bid phrases 3A30, defining advertising spend and budget-oriented parameters 3A40, creating advertising copy and advertising imagery 3A50, and activating the campaign 3A60. In various embodiments, one or more of the steps 3A10, 3A20, 3A30, 3A40, 3A50, 3A60 might be performed on the basis of user interaction from a client system 105. In other embodiments one or more of the steps 3A10, 3A20, 3A30, 3A40, 3A50, 3A60 might be performed either fully automatically, or in a computer-aided manner. In an exemplary embodiment, the step providing some initial information about the products or services to be advertised 3A10 might include a screen device 3A15 for requesting a user to merely identify a web page that features the products or services to be advertised. Of course a wide range of information about the subject product or service might be retrieved from the identified web pages, including information on geographic location, appropriate geographic scope, keywords, images and style for creative advertisement generation.

FIG. 3B shows a screen device 3B00 for a campaign set-up procedure for defining advertising copy for an advertising campaign, according to an exemplary embodiment using a graphical user interface. As shown, one or more fields, (e.g. fields 3B10, 3B20, 3B54, 3B30) might be populated manually via a text field or other screen device, or they might be populated either fully automatically, or in a computer-aided manner, possibly by the additional content server 108. Similarly, one or more fields, including fields 3B56 and 3B70 might be presented to a user via a text field or other screen device, and/or they might be populated fully automatically into a database. In other embodiments, the screen device is optional, and instead of (or in addition to) a graphical user interface, a web service is defined so as to support a protocol for populating the fields (e.g. fields 3B10, 3B20, 3B54, 3B30, etc).

The screen devices at 3B54 and 3B56 serve to capture and apply flashy text style to the catch phrase. For example, a pull-down menu 3B56 might offer style options (e.g. change color, add shadow, add blinking, and other). In addition to applying a style, the screen device at 3B80 serves to identify an object used in the intended display advertisement. For example, the object identified by the filename or URL at 3B80 might identify an animated display object (e.g. Macromedia Flash™, Adobe Flash Video™, Microsofti™ Silverlight™, a JAVA™ object, etc), and such an object might be uploaded to the campaign server and made available for use in the intended display advertisements. Indeed, in some embodiments a selection of style and/or identification of an animated display object might be captured into a database and carried with the advertisement. The area at 3B40 serves to display the advertisement as it would look when composited into a search results web page. In particular, the Ad Preview 3B40 shows a preview of the advertisement including the catch phrase text, presented using the style characteristics as selected using pull-down 3B56 and or using the animated display object captured in 3B80. Of course the screen 3B00 is strictly an example, and any variety of screen devices might be used to capture field values, and in fact various embodiments of screen 3B00 that implement a plurality of catch phrase screen devices are possible and envisioned.

As shown, the screen device of FIG. 3B depicts elements of text-based advertisements. Text-based advertisements are just one option for advertisements, and in a more general case, an advertisement including flashy text might be constructed from any combination of text, images, hypertext, applets, display objects, and/or using any known techniques for presenting on a client system display.

Of course any number of screen devices might be provided for defining/editing any/all of the campaign characteristics (e.g. establishing services to be advertised 3A10, establishing geographic coverage 3A20, defining keywords and bid phrases 3A30, defining advertising spend and budget-oriented parameters 3A40, creating advertising copy and advertising imagery 3A50, and activating the campaign 3A60) and using such screen devices the advertiser or sponsor might change campaign settings over time. For example, a sponsor might want to disable an advertisement, or might want to control the time periods and/or geographies in which an advertisement impression appears.

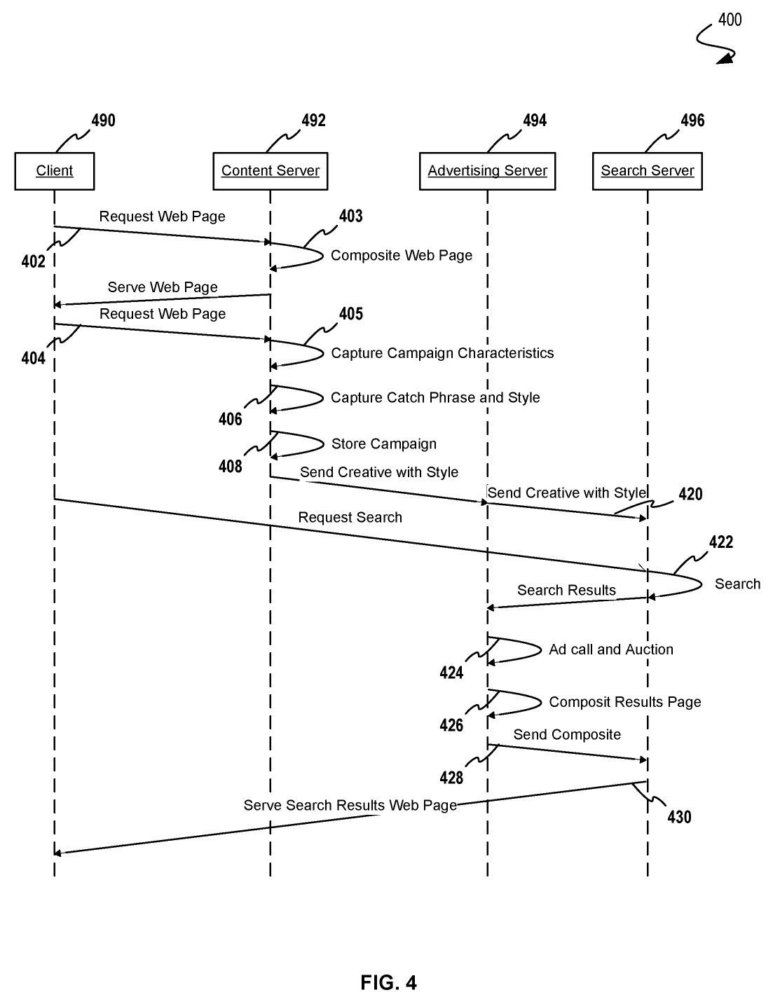

FIG. 4 is a diagrammatic representation of several computer systems (i.e. client 490, content server 492, advertising server 494, and search server 496) in the exemplary form of a client server network 400 within which environment a communication protocol may be executed, according to one embodiment. The embodiment shown is purely exemplary, and might be implemented in the context of one or more of FIG. 1A through FIG. 3B. As shown a client 490 is capable of initiating a communication protocol by requesting a web page (transaction 402). Such a request might be satisfied solely by a content server 492 (operation 403), or it might be satisfied by a content server 492 in conjunction with any number of additional content servers or advertising servers 494 acting in concert. With regard to methods for attention-grabbing display results for sponsored online advertising campaigns, the operations might start from a client requesting a web page 404, and proceed with operations for capturing campaign characteristics 405, capturing catch phrases and style 406, and storing the campaign 408. In this embodiment, the creative is sent to the advertising server, and also to the search server (transaction 420). At this point in the protocol, the campaign is described in such a manner that a search results page can be composited as a response to a search request. Specifically, the search server 496 responds to a search request by performing the search 422 and providing the search results with an ad call 424. The advertising server picks up the ad call, facilitates the auction 424, and composes the results page 426 including any advertisements for which a spot was secured in the auction. The composite search results web page is transmitted to a server, for example, the search server (see transaction 428) and then transmitted to the requesting client as a fully composited search results web page (see transaction 430). Of course the composition of the composite search results web page including the sponsored advertisements with flashy text might be performed on any server, or even the client system for that matter.

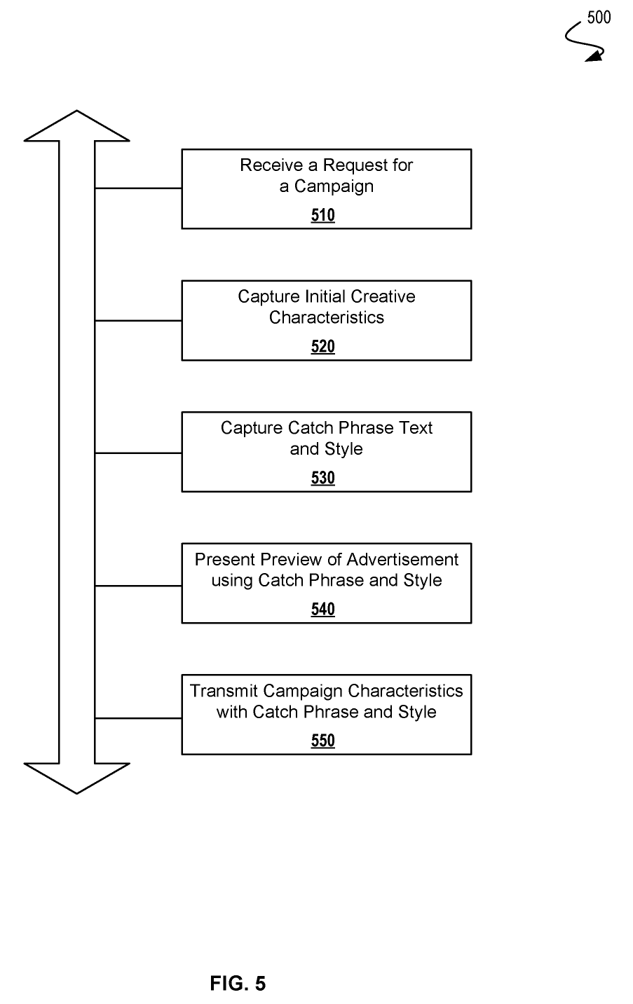

FIG. 5 is an operations chart showing a system and method for attention-grabbing display results for sponsored online advertising campaigns, according to one embodiment. As an option, the present system 500 may be implemented in the context of the architecture and functionality of FIG. 1A through FIG. 4. Of course, however, the system 500 or any operation therein may be carried out in any desired environment. As shown, the operation 510 receives a request for a campaign to be established. Accordingly, at least a portion of operation 520 executes, soliciting inputs from a user or bot. At some point during the execution of operation 520, the requesting user is asked for inputs in operation 530 as to an advertisement catch phrase and style. Of course the style may include any sort of typographical style (e.g. type of font, font style, underline, strikethrough, shadow, superscript, subscript, etc), any sort of size within a range (e.g. 9 point, 12 point, etc), any sort of color definition (e.g. RGB, CMYK, etc), any sort of treatment (e.g. blinking, fade-in/fade-out, etc) and any sort of coding (e.g. CSS, Flash, Silverlight, etc). In fact the style definition may be applied independently to each character of any text in the catch phrase. At least as early as such time as at least some of the campaign creative characteristics have been captured, operation 540 serves to present a preview of the creative advertisement to the user. In some embodiments, the campaign characteristics are transmitted to one or more servers for persistent storage and use in presenting advertisements according to the characteristics of the campaign (see operation 550). Moreover, in various embodiments, the preview might display the online advertisement by simulating display characteristics (e.g. size, resolution, color range, contrast, etc.) various screen types (e.g. a VGA display, a widescreen monitor LCD, a smart phone display, etc).

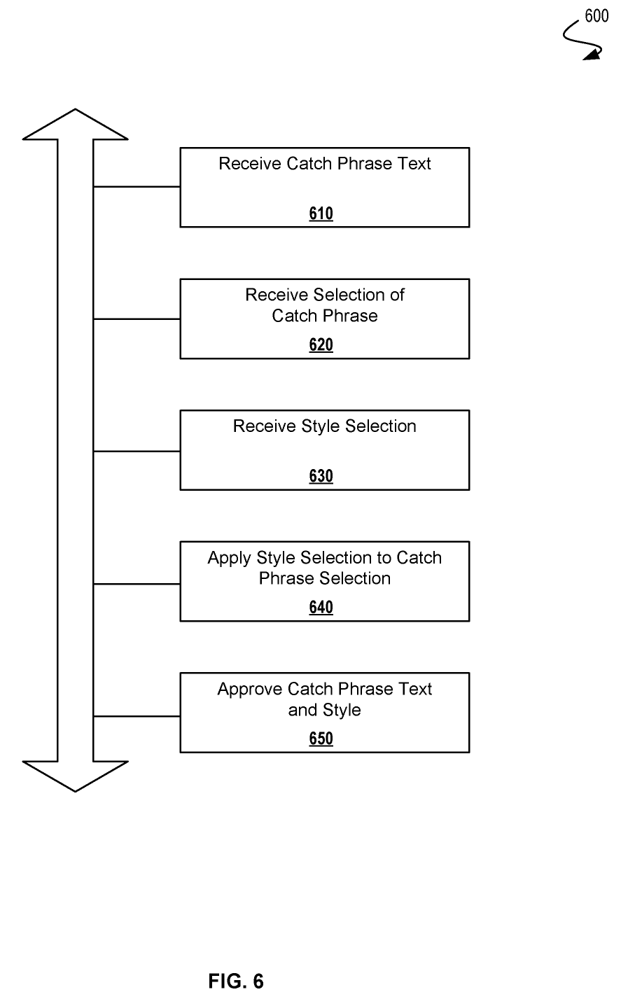

FIG. 6 is an operations chart showing a system and method for applying style to a catch phrase, according to one embodiment. As an option, the present system 600 may be implemented in the context of the architecture and functionality of FIG. 1A through FIG. 5. In particular, system 600 might be included in embodiments of operations 530 and/or 540. Of course, however, the system 600 or any operation therein may be carried out in any desired environment. As shown the system 600 receives catch phrase text (see operation 610), a selection of one or more characters of the catch phrase (see operation 620), a style selection (see operation 630), and applies the style to the selected character or characters (see operation 640). In some embodiments, any elements of the catch phrase and any applied styles are subject to an approval step (see operation 650). As depicted, the operations 610, 620, 630, 640, 650 may each operate asynchronously, and begin/pend/resume at any time. Thus, any style might be applied to any portion or selection of a catch phrase, and any portion or selection might be approved, and such a sequence might be repeated iteratively.

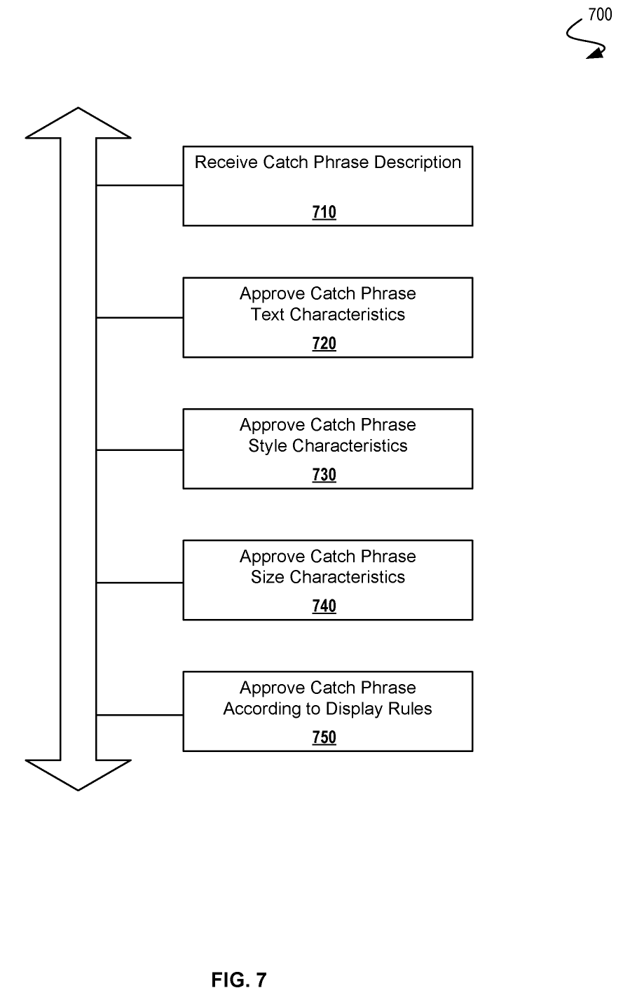

FIG. 7 is an operations chart of a system and method for approving a stylized catch phrase, according to one embodiment. As an option, the present system 700 may be implemented in the context of the architecture and functionality of FIG. 1A through FIG. 6. In particular, system 700 might be included in embodiments of operations 650. Of course, however, the system 700 or any operation therein may be carried out in any desired environment. As shown the system 700 receives a stylized catch phrase description (see operation 710) and processes the stylized catch phrase in order to approve the stylized catch phrase for display. The approval steps may include approval of the word or words of the catch phrase (see operation 720), approval of the catch phrase style characteristics inasmuch as some combinations of styles may be deemed unflattering, and might not be approved (see operation 730), and an estimation and approval of the layout size of the catch phrase (see operation 750) so as to confirm the size of the catch phrase (once the styles have been applied) can be displayed within the permitted bounding box (see operation 740). Of course any number of other approval steps of the words or phrases of the catch phrase might be performed so as to be in line with editorial and/or display guidelines (see operation 750).

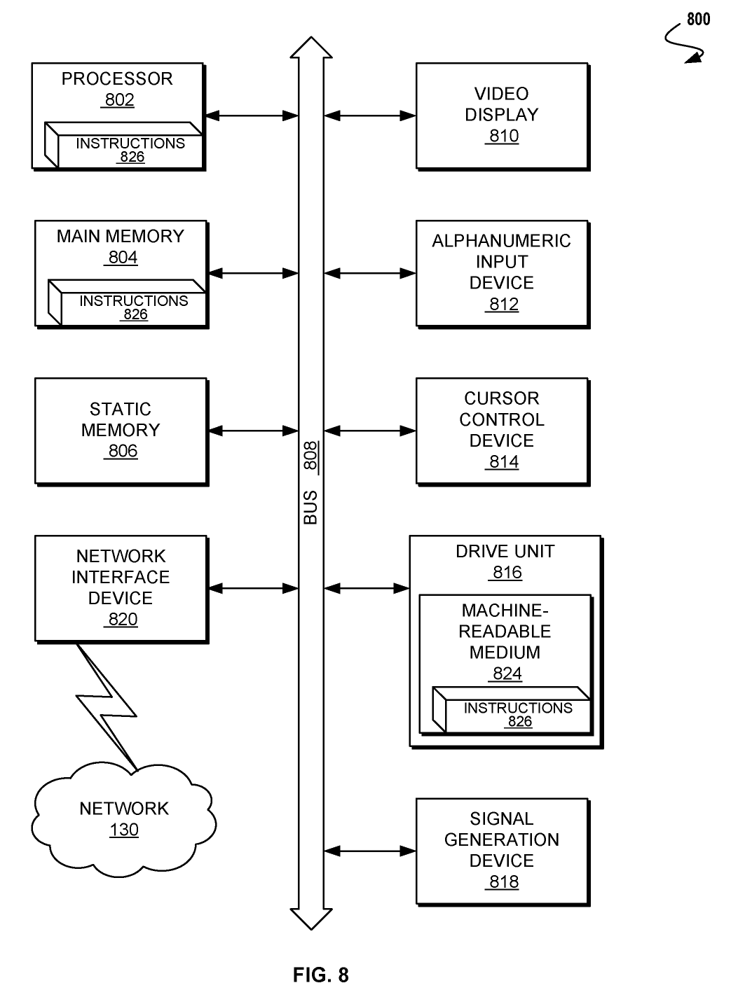

FIG. 8 shows a diagrammatic representation of a machine in the exemplary form of a computer system 800 within which a set of instructions, for causing the machine to perform any one of the methodologies discussed above, may be executed. The embodiment shown is purely exemplary, and might be implemented in the context of one or more of FIG. 1A through FIG. 7. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810 (e.g. a liquid crystal display (LCD) or a cathode ray tube (CRT)). The computer system 800 also includes an alphanumeric input device 812 (e.g. a keyboard), a cursor control device 814 (e.g. a mouse), a disk drive unit 816, a signal generation device 818 (e.g. a speaker), and a network interface device 820.

The disk drive unit 816 includes a machine-readable medium 824 on which is stored a set of instructions (i.e., software) 826 embodying any one, or all, of the methodologies described above. The software 826 is also shown to reside, completely or at least partially, within the main memory 804 and/or within the processor 802. The software 826 may further be transmitted or received via the network interface device 820 over the network 130.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc.); or any other type of media suitable for storing or transmitting information.

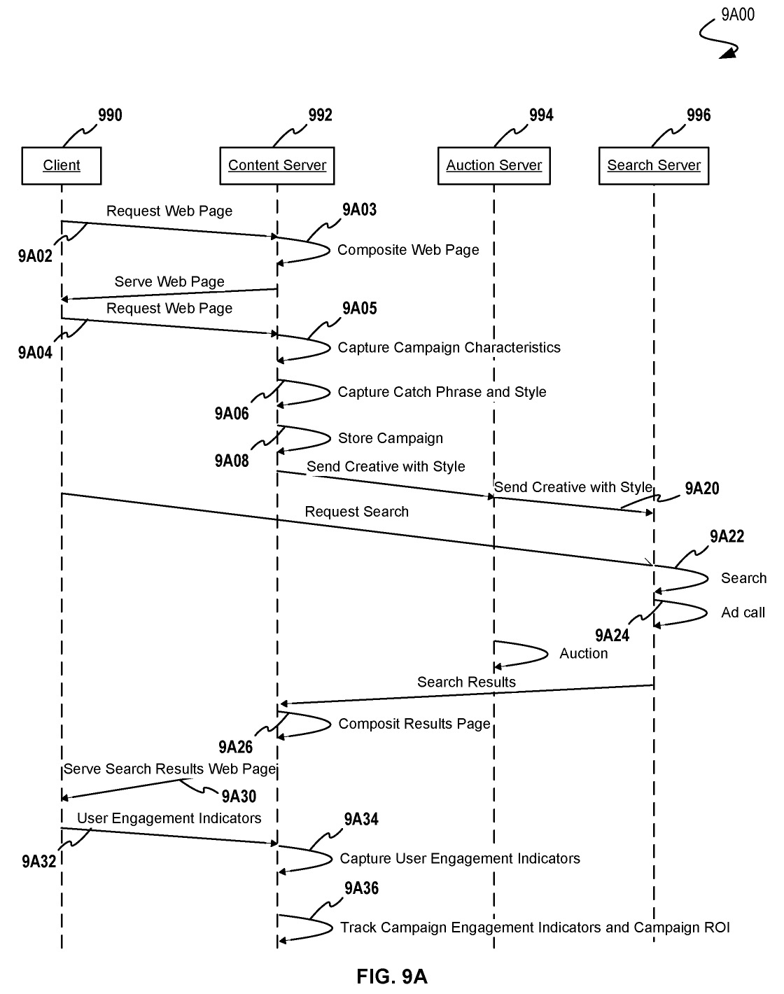

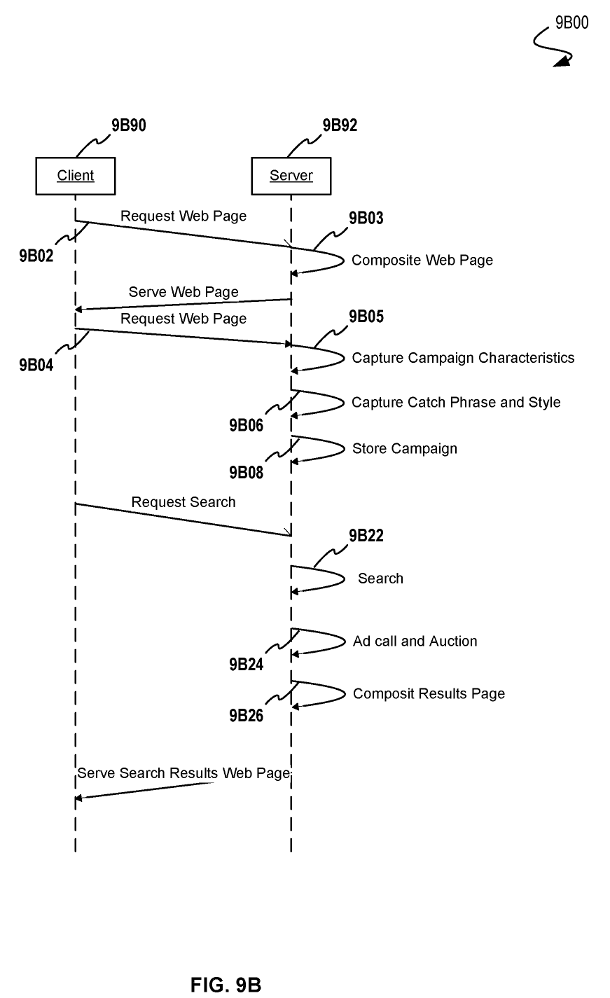

FIG. 9A is a diagrammatic representation of several computer systems (i.e. client 990, content server 992, auction server 994, and search server 996) in the exemplary form of a client server network 900 within which environment a communication protocol may be executed. The embodiment shown is purely exemplary, and might be implemented in the context of one or more of FIG. 1A through FIG. 8. The system 9A00 implements communication protocol for creating an online advertisement for sponsored search web pages using a stylized catch phrase. As shown the operations 9A04, 9A06 serve for presenting an interface for composing the advertisement. This embodiment includes an operation for capturing one or more catch phrases and styles. The operations 9A06 and 9A08 serve for creating a stylized catch phrase by applying at least one style to at least a portion of the catch phrase, approving the stylized catch phrase in the context of the online advertisement, and storing the approved advertisement. Of course given the stored advertisement, the advertisement containing the stylized catch phrase can be composited with search results (operation 9A26) and then transmitted to a client (message 9A30). In exemplary embodiments, user actions, including a class of actions termed user engagement indications might be collected at the client and any variety of user actions (e.g. clicks, hovering, timing between clicks and hoverings, etc) might be transmitted to a server (see transmission 9A32) for collection and later processing (see operation 9A34). Such later processing might include tracking aggregating user actions collected subsequent to display of a search results web page, or might include tracking actions as related to advanced or complex demographics, or might include any variety of fine-grained statistics (see operation 9A34). Using such tracking and demographic information, an advertiser might monitor performance of advertisements, and might then manipulate campaign settings in order to build still higher performing advertising campaigns. Of course any or all of the aforementioned tracking and statistics might be used by publishers. As a specific example, an advertiser (or publisher) might be able to identify demographics that are statistically correlated to specific user actions. In other words, advertisers and publishers can identify the ‘where’ (e.g. geographic location) and the ‘who’ (e.g. demographic such as age group or other targeted demographic) of user segments that are passionate (e.g. action prone) about an advertisement. As is readily understood, an advertiser might concurrently enable multiple campaigns. Accordingly, the techniques for tracking user engagement, user demographics, and ROI in a given campaign (see operation 9A36) permit comparisons of that campaign to any one or more other campaigns.

The embodiment of 9A00 shows a client 990 and a plurality of servers 992, 994, 996, however the division of operations between the plurality of servers 992, 994, 996 is strictly exemplary, and the method for creating an online advertisement for sponsored search web pages using a stylized catch phrase might be implemented on fewer (or more) servers. Indeed, the system 9B00 of FIG. 9B implements communication protocol for creating an online advertisement for sponsored search web pages using a stylized catch phrase using only a single client 9B90 and a single server 9B92.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for creating an online advertisement for sponsored search web pages using a stylized catch phrase comprising:
presenting an interface for composing the advertisement wherein the interface for composing includes at least one operation for capturing the catch phrase;
creating a stylized catch phrase by applying at least one style to at least a portion of the catch phrase;
approving the stylized catch phrase in the context of the online advertisement; and
transmitting the stylized catch phrase within at least one online advertisement impression.

2. The method of claim 1 wherein the presenting an interface includes a graphical user interface.

3. The method of claim 1 wherein the presenting an interface includes a web service.

4. The method of claim 1 wherein the presenting an interface includes presenting a plurality of catch phrase screen devices.

5. The method of claim 1 wherein the creating a stylized catch phrase includes applying at least one of, a typeface, a font size, a color, a shadow, a treatment, an applet.

6. The method of claim 1 wherein the approving the stylized catch phrase includes an editorial approval.

7. The method of claim 1 wherein the approving the stylized catch phrase includes simulating the online advertisement for display on at least one of, a VGA display, a widescreen monitor, a smart phone display.

8. The method of claim 1 wherein the approving the stylized catch phrase includes a sponsor approval.

9. The method of claim 1 wherein the transmitting the stylized catch phrase includes transmitting a web page.

10. The method of claim 1 wherein the transmitting the stylized catch phrase includes transmitting a web page. The method of claim 1 wherein the transmitting the stylized catch phrase includes transmitting a web page.

11. A system for creating an online advertisement for sponsored search web pages using a stylized catch phrase comprising:
a module for presenting an interface for composing the advertisement wherein the interface for composing includes at least one operation for capturing the catch phrase;
a module for creating a stylized catch phrase by applying at least one style to at least a portion of the catch phrase;
a module for approving the stylized catch phrase in the context of the online advertisement; and
a module for transmitting the stylized catch phrase within at least one online advertisement impression.

12. The system of claim 11 wherein the presenting an interface includes a graphical user interface.

13. The system of claim 11 wherein the presenting an interface includes a web service.

14. The system of claim 11 wherein the presenting an interface includes presenting a plurality of catch phrase screen devices.

15. The system of claim 11 wherein the creating a stylized catch phrase includes applying at least one of, a typeface, a font size, a color, a shadow, a treatment, a flash object.

16. The system of claim 11 wherein the approving the stylized catch phrase includes simulating the online advertisement for display on at least one of, a VGA display, a widescreen monitor, a smart phone display.

17. The system of claim 11 wherein the approving the stylized catch phrase includes a sponsor approval.

18. The system of claim 11 wherein the transmitting the stylized catch phrase includes transmitting a web page.

19. The system of claim 11 wherein the transmitting the stylized catch phrase includes transmitting a web page.

20. A computer program product embodied on a tangible computer readable medium for creating an online advertisement for sponsored search web pages using a stylized catch phrase comprising:
computer code for presenting an interface for composing the advertisement wherein the interface for composing includes at least one operation for capturing the catch phrase;
computer code for creating a stylized catch phrase by applying at least one style to at least a portion of the catch phrase;
computer code for approving the stylized catch phrase in the context of the online advertisement; and
computer code for transmitting the stylized catch phrase within at least one online advertisement.
